(19) United States
(12) Patent Application Publication
(10) Pub. No.: US 2004/0102192 A1
(43) Pub. Date: May 27, 2004

(54) Method and system for discovery and display of operating wireless networks

(75) Inventor: Zeljko John Serceki, Santa Rosa, CA (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/304,482

(22) Filed: Nov. 26, 2002

(51) Int. Cl. H04B 17/00; H04L 12/28; H04Q 7/20

(52) U.S. Cl. 455/434; 455/67.7; 370/431

(57) ABSTRACT

A wireless LAN monitoring application runs on a computing device and scans through all possible wireless channels. The application then displays information indicative of the communication activity level on each channel and permits a user to select a channel having an access point with which to associate. The selection may be based on a desired network the user wishes to access, a channel that has the highest signal-to-ratio, signal quality, or channel utilization or, when looking for a channel to set up an ad hoc network, a channel that has a low signal-to-noise ratio, signal quality, or channel utilization.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to wireless networks. More particularly, the invention relates to a method and system for discovery and display of operating wireless networks. More particularly still, the invention relates to a software tool running on a computer with wireless capability that detects the presence of one or more operating wireless networks (e.g., IEEE 802.11) and displays related information on the computer.

2. Background of the Invention

Initially, computers were most typically used in a standalone manner. It is now commonplace for computers and other types of electronic devices to communicate with each other over a network. The ability for computers to communicate with one another has led to the creation of small networks comprising two or three computers and vast networks comprising hundreds or even thousands of computers. Networks can be set up to provide a wide assortment of capabilities. For example, networks of computers may permit each computer to share a centralized mass storage device or printer. Further, networks enable electronic mail and numerous other types of services. Networks are available in a wired configuration in which each entity on the network has a direct physical electrical connection to the network. More recently, wireless network technology has made it possible for computers and other types of electronic devices to access a network in a wireless manner.

One popular type of wireless network is governed by the IEEE 802.11 standard. The scope of the present disclosure, however, is not limited to IEEE 802.11 networks, but simply uses the 802.11 network to exemplify the preferred embodiments of the invention. The 802.11 standard permits several different techniques to configure a wireless network. As shown in FIG. 1, one type of network includes one or more access points (“APs”) 10 coupled via a landline 14 to other devices such as a server 12. This type of architecture is called an “infrastructure” configuration. Devices 16 communicate wirelessly with the access points 10. Devices 16 may be portable or non-portable and may comprise computers with 802.11 wireless cards contained therein, handheld computing devices, or in general any device capable of wirelessly communicating with an AP. In this disclosure, devices 16 are referred to generically as wireless stations (“WSTAs”). The wireless stations 16 communicate with the server 12 or other network devices via the access points 10. As such, the access points provide each wireless station a wireless entry into the network.

FIG. 2 shows a second type of network configuration referred to as an “ad hoc” network. In an ad hoc network there is no particular structure to the network. Each wireless station is usually able to communicate directly with every other wireless station. Ad hoc networks are useful, for example, in a meeting to which a group of employees have brought their wireless-capable notebook computers. The employees can then set up an ad hoc network between themselves to share information.

Although wireless local area network (“WLAN”) technology generally works very well, there still are problems and issues to solve with regard to WLANs. For example, with regard to the network architecture of FIG. 1, when a wireless station 16 is powered on, the station “associates” itself with an access point 10. Because a WSTA 16 may be portable, the WSTA will not necessarily know ahead of time which AP with which to associate. As shown in FIG. 1, two of the WSTAs 16 are associated with one AP 10 and three WSTAs are associated with the other AP. The 802.11 standard provides for a plurality of frequencies (also called “channels”) on which the WSTAs and APs can communicate with one another. For example, one implementation of the 802.11 network (IEEE 802.11b) provides for 14 channels in a frequency band at 2400 MHz. Each AP 10 is configured for one of the 14 channels. Adjacent APs (i.e., APs within range of each other) must be configured for different channels. When a WSTA 16 is attempting to associate with an AP, the WSTA employs any one of a plurality of techniques for determining which AP to access. For example, the WSTA may scan through the 14 channels until it finds an AP and associates with the first AP it finds. The problem, however, is that there may be more than one WLAN in the area. This may happen because two different organizations, each with its own WLAN, are located adjacent one another in the same building. Also, a single organization may have multiple WLANs such a WLAN for the accounting department and a separate WLAN for the engineering department. Either way, current association techniques may result in a WSTA associating with an unintended WLAN. Moreover, the user of WSTA typically has little control over which WLAN to access if more than one WLAN is available to that user.

With regard to the configuration of FIG. 2, the creation of the ad hoc network requires the members of the network to agree to the use of one particular channel. Typically, this occurs by either the users simply agreeing to a particular channel and trying that channel to see if it works correctly or one of the user's WSTA can scan the channels to find the first “free” channel (i.e., a channel on which there are no communications). Although these techniques work, greater flexibility in channel selection would be highly desirable. Accordingly, a solution to these problems is desirable.

### BRIEF SUMMARY OF THE INVENTION

The problems noted above are solved in large part by a wireless LAN monitoring application that scans through all possible channels, displays information indicative of the activity level on each channel, and permits a user to select a channel having an access point with which to associate. The application can be run on any suitable wireless station (“WSTA”) that has a display, such as a notebook computer with a radio module. When desired, the user can have the WLAN application scan all possible channels to determine whether any access points are operating on any of the channels. If the application does detect the presence of an operating access point on a particular channel, the application determines the communication activity level associated with that access point and shows information on the notebook's display indicative of the activity level. The activity level can be measured in terms of signal-to-noise ratios (“SNRs”) in accordance with known techniques. Thus, the WLAN application can display a SNR level for each channel which permits the user to determine which channels have operating access points and the relative signal strength associated with each access point.

In accordance with a preferred embodiment, the WSTA running the WLAN monitoring application scans each channel either passively or actively. Passive scanning entails tuning the WSTA's radio module to a channel frequency and waiting a predetermined period of time for a “beacon” frame from an access point. A beacon frame includes the access point's MAC address and an identifier value that uniquely identifies the network to which the access point pertains (e.g., an SSID in the context of an IEEE 802.11 network). Such MAC address and network identifiers preferably are also displayed by said WLAN monitoring application.

Such a system permits the user to select one of a plurality of independent WLANs to access. Once the user decides which network to access, the user uses an input device (e.g., keyboard or mouse) to select an access point that is operating and associates with the desired network. Such a system also permits the user to select the access point that has the highest SNR.

Further still, the system permits easy creation of ad hoc networks. A user of a WSTA running the WLAN monitoring application can select the channel for the ad hoc network to be a channel that has a zero or very low SNR indicating that no access point or other WSTA is operating on the channel.

Moreover, the preferred embodiments disclosed herein provide a flexible tool for a user to configure and modify the operation of a WLAN. These and other benefits will become apparent upon reviewing the following disclosure.

### BRIEF DESCRIPTION OF THE DRAWINGS

For a detailed description of the preferred embodiments of the invention, reference will now be made to the accompanying drawings in which:

FIG. 1 shows an infrastructure configuration of a wireless network;

FIG. 2 shows an ad hoc wireless network configuration;

FIG. 3 shows a system diagram of a preferred embodiment of the invention having a wireless LAN monitoring application that scans through all possible channels, displays information indicative of the activity level on each channel, and permits a user to select a channel having an access point with which to associate; and

FIG. 4 shows a preferred embodiment of a graphical user interface associated with wireless LAN monitoring application.

### NOTATION AND NOMENCLATURE

Certain terms are used throughout the following description and claims to refer to particular system components. As one skilled in the art will appreciate, wireless equipment providers may refer to a component by different names. This document does not intend to distinguish between components that differ in name but not function. In the following discussion and in the claims, the terms “including” and “comprising” are used in an open-ended fashion, and thus should be interpreted to mean “including, but not limited to.”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

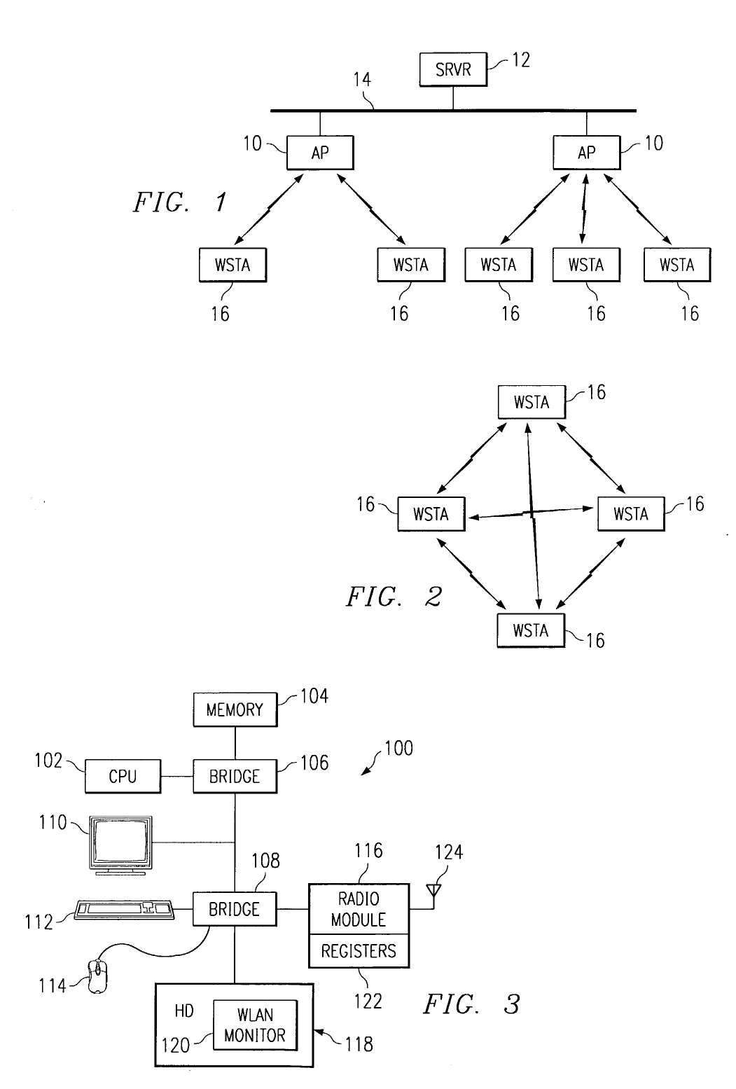

Referring now to FIG. 3, a wireless station 100 is shown constructed in accordance with a preferred embodiment of the invention. The wireless station 100 preferably includes a CPU 102, memory 104, bridge devices 106 and 108, a display 110, input devices, such as a keyboard 112 and mouse 114, a radio module 116 and a hard disk drive 118. The WSTA 100 may be implemented as a desktop or portable computer, but this disclosure is not so limited. The CPU 102 and memory 104 couple to the bridge 106 which also has a connection to bridge 108. The display 110 may include a graphics processor and monitor and connect to the bus interconnecting the bridges 106 and 108 or be connected in any other desired arrangement. The keyboard 112 and mouse couple to the bridge 108, as do the radio module 116 and hard drive 118.

The radio module 116 includes a bus interface and transceiver electronics (not specifically shown) and one or more antennas 124. The radio module also includes registers 122 some of which are readable and writeable by CPU 102, while others are readable and writeable by the radio module's electronics. The registers preferably contain status, configuration and other information as will be explained below. A suitable example of a radio module is the ACX100 WLAN provided by Texas Instruments Inc.

The hard drive 118 preferably contains one or more software applications which can be executed by CPU 102. Of particular relevance to the preferred embodiments described herein is the WLAN Monitor application 120 contained on the hard drive. When the user desires to run this application, the computer's operating system copies it to memory 104, which comprises random access memory (“RAM”), and the application is then retrieved from memory 104 by CPU 102 for execution in accordance with known techniques.

The WLAN Monitor application 120 provides several functions in accordance with the preferred embodiment of the invention. In general, the WLAN Monitor application informs a user of the wireless communication activity level present on each channel. Using the capabilities of the radio module 116, the WLAN Monitor application scans through each of the potential channels usable in a WLAN and provides the user a visual representation of the level of wireless communication activity on each channel. The user can then perform various actions based on that information.

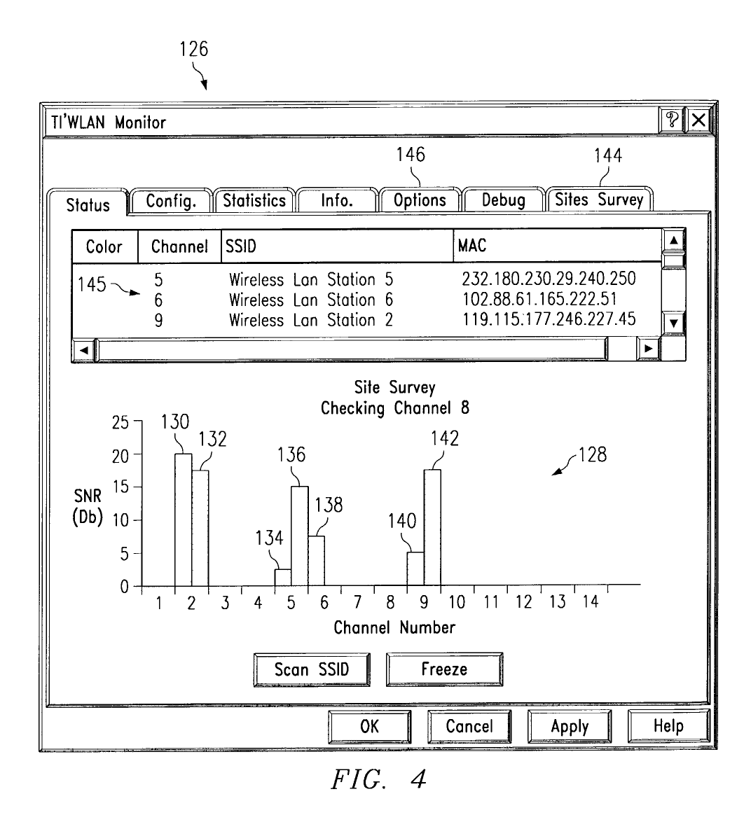

FIG. 4 shows an exemplary graphical user interface (“GUI”) 126 associated with the WLAN Monitor application 120. The GUI 126 includes a graphical representation 128 of the communication activity on the various channels (channels 1-14 in the context of 802.11b networks) and connection information status area 145 pertaining to the various channels identified in the graphical representation 128. The graphical representation 128 includes the identifiers or channel numbers of all possible channels along the horizontal axis. The vertical axis provides an indication of the level of communication activity for each channel. In this context, the term “level of communication” (or “communication activity level”) refers to signal quality, channel utilization or other parameters which is indicative of the communication level on a particular channel. In accordance with one preferred embodiment of the invention, the vertical axis includes an indication of the signal-to-noise (“SNR”) of transmissions present on the various channels as a metric of the level of communication of the channels. SNR is generally regarded to be the ratio of the amplitude of a desired signal to the amplitude of noise at the same frequency as the desired signal. In general, noise will be present on most, if not all, channels. The noise present on a channel is typically generated by other unrelated devices and is generally unavoidable. Higher SNR values indicate that the level of the desired signal on the channel is higher than the level of noise on that channel's frequency, as compared to lower SNR values. How the WLAN Monitor application 120 determines the SNRs for each channel will be described below. Other metrics besides SNR can also be used to indicate the level of communication on the channels.

Referring still to FIG. 4, as shown in the graphical representation 128 portion of the GUI 126, several channels have SNRs greater than 0, namely, channels 2, 5, 6 and 9. As can be seen, the WLAN Monitor has displayed two SNRs 130, 132 for channel 2, two SNRs 134 and 136 for channel 5, one SNR 138 for channel 6, and two SNRs 140, 142 for channel 9. This means that two APs are operating on channel 2, three APs are operating on channel 5, one AP is operating on channel 6, and two APs are operating on channel 9. This graphical representation also informs the user that channels 1, 3, 4, 7, 8, and 10-14 have zero or negligible SNR and thus are available for use for wireless communications (at least at the location of wireless station 100).

WLAN Monitor application 120 determines the SNR for each channel as follows. FIGS. 3 and 4 should be consulted for the following discussion. When Sites Survey software button 144 is selected by the user of the application, the WLAN 100 preferably scans all of the channels beginning with channel 1. The channel scan can be passive or active as selected by the user in the Options menu choice 146 or as is preprogrammed into the WLAN Monitor application. In passive scanning, the radio module 116 is tuned to a channel frequency and waits for a predetermined period of time until it detects a “beacon” signal from an AP. In accordance with the 802.11 standard, each AP emits a beacon signal at periodic intervals (e.g., every 100 milliseconds). Each beacon signal preferably includes the AP's MAC address and an identifier of the network with which the AP is a member. That identifier could be a service set identifier (“SSID”) as is defined in the 802.11 standard. The WSTA's CPU preferably extracts the information from the beacon and displays some or all of such information in the connection information status area 145. The WSTA will be tuned to the next channel in sequence once it detects a beacon for the current channel or once the predetermined period of time has expired without detecting a beacon.

Once a beacon is detected, the CPU 102 accesses a register within the radio module and processes the value contained in the register through a software program to compute the SNR. If the radio module 116 comprises Texas Instrument's ACX100, then the register accessed is the snr_register value and the SNR value preferably is computed according to the following formula:

SNR=10*(log(50)−log(snr_{—}register_{—}value*128/264))

where the log operation is the “base 10” logarithm function and the snr_register_value is a number between 0 and 255.

In some instances, the WSTA will detect beacons from more than one AP on the same channel. This is the case for channels 2, 5 and 9 in FIG. 4. The WSTA preferably determines or computes the SNR associated with each AP's beacon and displays such information as shown in FIG. 4.

In active scanning, the WSTA 100 tunes its radio module 116 to each channel in succession. For each channel frequency, the WSTA transmits a probe request in accordance with the 802.11 standard to which an AP, tuned to the same channel will respond. The response from an AP is in the form of a probe response (also in accordance with the 802.11 standard) and contains the AP's MAC address and network identifier information (e.g., SSID). If no probe response is received by the WSTA within a given period of time (e.g., 5 seconds), the WSTA determines that no AP is available and operating on that channel and tunes its radio module to the next channel in sequence.

Referring still to FIG. 4, connection information 145 includes an entry for each channel for which the SNR indicates the presence of one or more APs. Each entry preferably includes the channel number and network identifier (“SSID”) and MAC address for the AP. Other information can be supplied as well.

The ability to scan through all of the channels and inform the user of which channels have active APs, provides the user the flexibility to do various operations not previously believed to be possible. For instance, the SSID information for each channel can be encoded to reflect the identity of the network to which the AP pertains. The SSID value for an AP associated with the accounting department could be encoded as “ACCOUNTING,” while the SSID for an AP associated with the engineering department could be encoded as “ENGINEERING.” The WLAN Monitor application 120 preferably permits the user the option of selecting the network with which to be associated. Thus, with the preferred embodiment, a user can determine that more than one WLAN is present and available to be connected to, and can connect to whichever network the user chooses. This selection can be made by clicking on the entry in connection information field 145 pertaining to the AP of the desired network. Alternatively, or additionally, the user can click on the bar SNR 130-142 corresponding to the AP of the desired network. Either way, selecting the desired AP will cause the user's WSTA to associate with the selected AP.

Another feature that is enabled by the WLAN Monitor application 120 is the ability to quickly set up an ad hoc network. As note above, it must be determined which channel will be used as the basis for the ad hoc network. To that end, a user desiring to be a member of the yet to be formed ad hoc network can use the WLAN Monitor to determine which channels are available for use by the ad hoc network. In the example of FIG. 4, the channels that are available include channels 1, 3, 4, 7, 8 and 10-14. The user can then select one of the available channels and all members of the ad hoc network can tune their radio modules to the selected channel in accordance with known techniques.

The preferred embodiments described above provide a flexible software tool that permits a user the ability to determine the status of all channels and select which channel to use. The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless station, comprising:
a CPU;
memory coupled to said CPU, said memory containing an application that is executed by said CPU;
a radio module coupled to said CPU; and
a display coupled to said CPU;
wherein, under operation by said application, said CPU causes said radio module to scan through a plurality of channels, determine a communication activity level for each channel indicating whether an access point is operating on each channel, and show information on said display indicating the activity level on each of said plurality of channels.

2. The wireless station of claim 1 further including an input device coupled to said CPU, said input device being usable to select one of the channels for which said information is shown on said display with which the wireless station is to associate.

3. The wireless station of claim 1 wherein said activity level comprises signal-to-noise ratios.

4. The wireless station of claim 3 wherein said information shown on said display includes said signal-to-noise ratios.

5. The wireless station of claim 4 further including an input device coupled to said CPU, said input device being usable to select one of the channels with which the wireless station is to associate based on the magnitude of said signal-to-noise ratios.

6. The wireless station of claim 1 wherein said information includes identifiers associated with said access points and further including an input device coupled to said CPU, said input device being usable to select one of the channels with which the wireless station is to associate based on said identifiers.

7. The wireless station of claim 4 further including an input device coupled to said CPU, said input device being usable to select a channel with which the wireless station is to associate, said selected channel has a signal-to-noise ratio indicating an access point is not operating on said channel.

8. A computer readable storage medium for storing an executable set of software instructions that are executable by a CPU, said software instructions being operable to inform a user of the communication activity that is occurring on each of a plurality of wireless channels, including:
(a) a means for determining the activity level of each of said plurality of channels;
(b) a means for displaying information indicative of said activity level; and
(c) a means for permitting the user to select one of the channels over which to communicate.

9. The computer readable storage medium of claim 9 wherein the activity level includes signal-to-noise ratios.

10. The computer readable storage medium of claim 9 wherein (c) includes a means for permitting the user to select a channel based on the signal-to-noise ratios.

11. The computer readable storage medium of claim 9 wherein (c) includes a means for permitting the user to select a channel based on the magnitude of the signal-to-noise ratios.

12. The computer readable storage medium of claim 9 wherein said information includes network identifiers associated with said channels.

13. The computer readable storage medium of claim 12 wherein (c) includes a means for permitting the user to select a channel based on the network identifiers.

14. The computer readable storage medium of claim 12 wherein (c) includes a means for permitting the user to select a channel that currently has no communication activity.

15. A method of controlling a wireless network having a plurality of channels, comprising:
(a) determining activity level of each of said plurality of channels;
(b) displaying information indicative of said activity level; and
(c) permitting a user to select one of the channels over which to communicate.

16. The method of claim 15 wherein the activity level includes signal-to-noise ratios.

17. The method of claim 16 wherein (c) includes permitting the user to select a channel based on the signal-to-noise ratios.

18. The method of claim 16 wherein (c) includes permitting the user to select a channel based on the magnitude of the signal-to-noise ratios.

19. The method of claim 16 wherein said information includes network identifiers associated with said channels.

20. The method of claim 19 wherein (c) includes permitting the user to select a channel based on the network identifiers.

21. The method of claim 19 wherein (c) includes permitting the user to select a channel that currently has no communication activity.

22. A method of establishing an ad hoc wireless network among a plurality of wireless stations operated by users, comprising:
(a) causing one of said wireless stations to scan through a plurality of channels and display information on a display device indicative of communication activity level for each channel;
(b) selecting one of the channels for which said information indicates that no access points or other wireless stations are currently operating on said channel; and
(c) establishing the ad hoc network using the selected channel.

23. The method of claim 22 wherein said information includes signal-to-noise ratios for each channel.
